(19) United States
(12) Patent Application Publication
(10) Pub. No.: US 2003/0228095 A1
(43) Pub. Date: Dec. 11, 2003

(54) System for and method of replicating optical pulses

(76) Inventors: Farhad Hakimi, Watertown, MA (US); Hosain Hakimi, Watertown, MA (US)

Correspondence Address: HALE AND DORR, LLP, 60 STATE STREET, BOSTON, MA, 02109

(21) Appl. No.: 10/211,659

(22) Filed: Aug. 2, 2002

Related U.S. Application Data
(60) Provisional application No. 60/387,467, filed on Jun. 10, 2002.

(51) Int. Cl. G02B 6/26

(52) U.S. Cl. 385/27

(57) ABSTRACT

A system and method of replicating optical pulses are disclosed. An optical pulse replicator includes a Fabry Perot interferometer operating in reflection mode. An optical signal distribution circuit has an input link, an output link, and a bi-directional link. The Fabry Perot interferometer optically communicates with the bi-directional link. According to one embodiment, the Fabry Perot interferometer includes an etalon having a first and second reflective surface. The first surface receives optical signals from the bi-directional link of the optical signal distribution circuit, and the first surface has a reflectivity of about 17% and up to 50%. The second surface has a reflectivity of about 24% and up to 50%. According to another embodiment of the invention, the Fabry Perot interferometer is tunable. According to another embodiment of the invention, the reflectivity of the surfaces create replicated pulses of approximately equal magnitude.

### CROSS-REFERENCE TO RELATED APPLICATIONS

This application claims the benefit of U.S. Provisional Application No. 60/387,467, entitled “Method and Apparatus for Optical Pulse Replication without Using Unbalanced Interferometer” filed on Jun. 10, 2002, 2002, which is hereby incorporated by reference in its entirety.

### BACKGROUND OF THE INVENTION

1. Field of the Invention

This invention relates generally to replicating optical pulses and more specifically to replicating optical pulses for use in optical communication.

2. Discussion of Related Art

Fiber optics links suffer from various fiber impairments that limit sending data at high rates. The major impairments include second order chromatic dispersion, polarization mode dispersion and fiber nonlinear effects (self-phase modulation, cross-phase modulation, four wave mixing).

Briefly, second order chromatic dispersion tends to broaden optical pulses because the various spectral components of an optical pulse have different speeds in a fiber. Polarization mode dispersion is caused by fiber shape asymmetries that cause two orthogonal polarization modes to travel at different speed in the fiber, hence broadening optical pulses in time. The time broadening is harmful when significant overlapping occurs between neighboring pulses in the same optical channel; this makes it more difficult to distinguish optical pulses (or lack of) in their bit period. With regard to non-linear effects, self-phase modulation (SPM) tends to broaden the spectrum of an individual optical channel, causing cross-talk with adjacent optical channels in a wavelength division multiplexed (WDM) systems. Cross-phase modulation degrades the quality of all WDM channels to various degrees by imprinting its own data pattern into others. With the four wave mixing process, two optical channels may create undesirable progenies. The progenies may overlap and interfere with existing neighboring channels resulting in serious optical channel degradations.

It has been shown that optical pulse replication may be used to alleviate the above fiber impairments. (See U.S. patent application Ser. Nos. 10/050,749; 10/050,635; 10/052,868; 10/053,478; 10/050,751; and 10/050,641, filed Jan. 16, 2002, assigned to the owners of this invention and incorporated by reference in its entirety). In particular, the patent applications, cited above, Michelson interferometers (MIs) and Mach-Zehnder interferometers (MZIs) are used as pulse replicating circuits within FIR filters to reduce one or more of the above impairments. The degree of impairment reduction has been the most effective when the magnitude of the pulses is substantially the same.

Unfortunately, though the devices described in the above patent applications are effective, they may be difficult to make in practice when high performance is required. The difficulties are two-fold: first, the mechanical sensitivity of the MIs and MZIs make them prone to mechanical and thermal noise in the bulk optic free space implementation, and second, the relative low quality of certain optical components degrades the performance of the MIs and MZIs (e.g., beam splitters, with tight tolerances for polarization insensitivity, equal splitting ratios). With specific regard to this latter point, commercially available beam splitters are polarization sensitive, and splitting ratios can vary by a few percent, depending on the input state of polarization. This effect is particularly more deleterious in MZI type devices.

Though one can build MZI and MI devices in integrated optic waveguide format, it is again difficult to fabricate the beam splitter with the desired tight tolerances (splitting ratio, polarization insensitivity).

### SUMMARY

The present invention provides a system and method of replicating optical pulses.

According to one aspect of the invention, an optical pulse replicator includes a Fabry Perot interferometer operating in reflection mode.

According to another aspect of the invention, an optical signal distribution circuit has an input link, an output link, and a bi-directional link. A Fabry Perot interferometer optically communicates with the bi-directional link. Optical signals are communicated to the replicator on the input link of the optical signal distribution circuit, and replicated pulses are communicated on the output link of the optical signal distribution circuit.

According to another aspect of the invention, the Fabry Perot interferometer includes an etalon having a first and second reflective surface. The first surface receives optical signals from the bi-directional link of the optical signal distribution circuit, and the first surface has a reflectivity of about 17%. The second surface has a reflectivity of about 24%.

According to another aspect of the invention, the Fabry Perot interferometer includes an etalon having a first and second reflective surface. The first surface receives optical signals from the bi-directional link of the optical signal distribution circuit, and the first and second surfaces have approximate equal reflectivity which ranges from 10% to 50%.

According to another aspect of the invention, the Fabry Perot interferometer is tunable.

### BRIEF DESCRIPTION OF THE DRAWINGS

In the Drawing.

FIG. 1 shows an exemplary Fabry-Perot interferometer;

FIG. 2 shows an exemplary frequency response of a Fabry-Perot interferometer operating in transmission mode;

FIG. 3 shows an exemplary time-domain impulse response of a Fabry-Perot interferometer operating in transmission mode;

FIG. 4 shows an exemplary pulse replicator according to certain embodiments of the invention;

FIG. 5 shows the frequency response of exemplary embodiments of the invention in relation to the frequency response of MI or MZI pulse replicators;

FIG. 6a shows the time domain, impulse response of exemplary embodiments of the invention;

FIG. 6b shows the time domain, impulse response of MI or MZI pulse replicators;

FIG. 7 shows an exemplary arrangement of cascaded pulse replicators according to certain embodiments of the invention; and

FIG. 8 shows exemplary arrangements of FPIRs.

### DETAILED DESCRIPTION

Under certain embodiments of the present invention, pulse replication is provided with a simple circuit that is less polarization sensitive and less costly to manufacture than MI and MZI approaches. As will be explained below, preferred embodiments use Fabry-Perot interferometers (FPI) in a reflection mode (as opposed to the more common use of FPIs in transmission mode). Certain embodiments use specific reflection amounts for the two reflective surfaces of the FPI to result in pulse amplitudes that are substantially identical (e.g., 17% and 24% for first and second surfaces). Other design parameters of the FPI may be tuned or altered to tune various characteristics of the replicated pulses, e.g., time delay between pulses, width of the pulses, amplitude difference among replicated pulses (such as 10% to 50% for first and second surfaces with approximate equal reflectivity), etc.

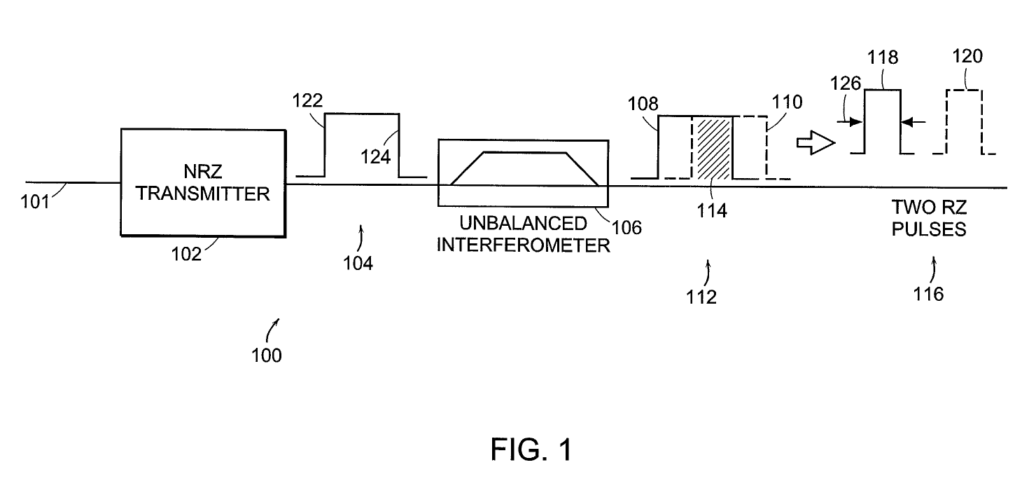

Briefly, FPIs are known devices that have been used in data communications and spectroscopy. Referring to FIG. 1, an FPI 101 typically consists of two parallel reflecting surfaces 102, 104 separated by a space 106 which may be filled with optically transmissive media having a refractice index n. FPIs are typically used in transmission mode in which an optical signal is communicated to the FPI on input 107 and an optical signal is emitted on an output 108. By proper choice of reflection coefficients for the two surfaces 102, 104, the FPI removes unwanted portions of the optical spectrum from the input signal.

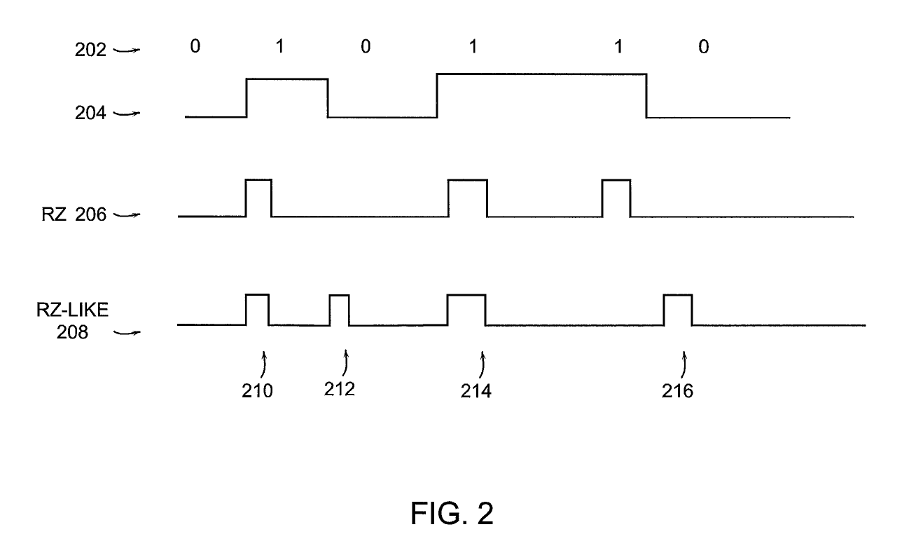

Referring to FIG. 2, the frequency domain response 202 of an FPI, operating in transmission mode, typically has peaks 204a . . . n at specific places, which are a function of Fabry-Perot thickness in space 106 and the index of refraction n of the media between the reflecting surfaces. The width 206a . . . n of each peak is a function of mirror reflectivity of the surfaces 102, 104 and the FP cavity loss. Cavity loss is a function of the separation distance, the cavity media, the mirror's parallelism, and the incident wavelength.

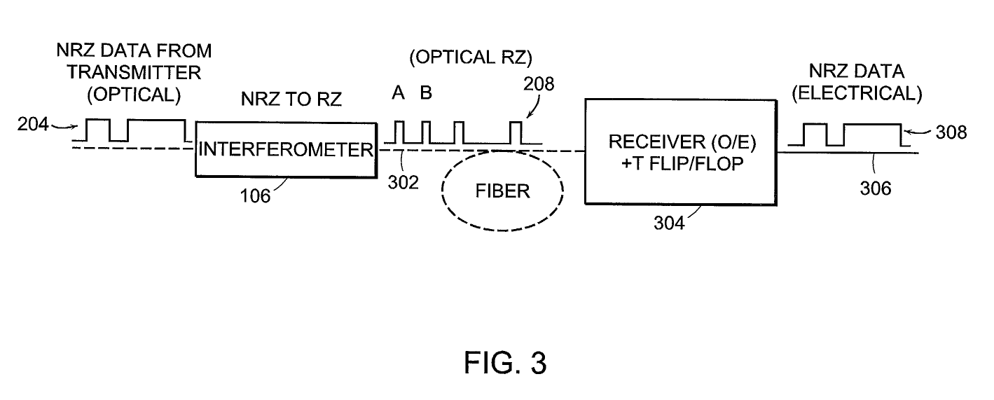

The description of an FPI, operating in transmission mode, can be described in the time domain by its impulse response function. Referring to FIG. 3, the impulse response 302 can have a series of pulses 306a . . . k, if the FPI reflector values are high enough and cavity loss are low. The pulses 306a . . . k are separated in time by a time delay that corresponds to light's round trip time of the cavity 106. Each pulse 306a . . . k decreases in intensity relative to prior pulses. This makes the FPI, in transmission mode, an inappropriate choice as a pulse replicator for certain desired applications, because the magnitude of the replicated pulses is unequal. In addition, the number of replicated pulses is hard to control.

Certain embodiments of the invention use an FPI as a pulse replicator. However, unlike conventional approaches to using FPIs, certain embodiments of the invention use the FPI in reflection mode (FPIR). The inventors have observed that an FPIR behaves quite differently than an FPI in transmission mode, and that the FPIR may be arranged to create replicate a pulse and to obtain certain characteristics.

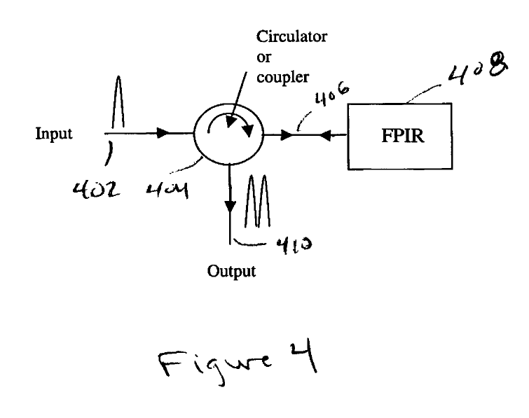

Specifically, FIG. 4 shows an exemplary embodiment of the invention, using an FPIR. Input 402 receives optical pulses and transmits them to circulator 404, or equivalent device such as a coupler,. The circulator 404 transmits pulses received on input 402 to link 406. Such pulses are then transmitted to FPIR 408. As will be explained in more detail below, FPIR 408 will generate a replicated pulse from the received pulse. The two pulses will then be sent on link 406 toward circulator 404. Circulator 404 transmits signals received on link 406 to output 410.

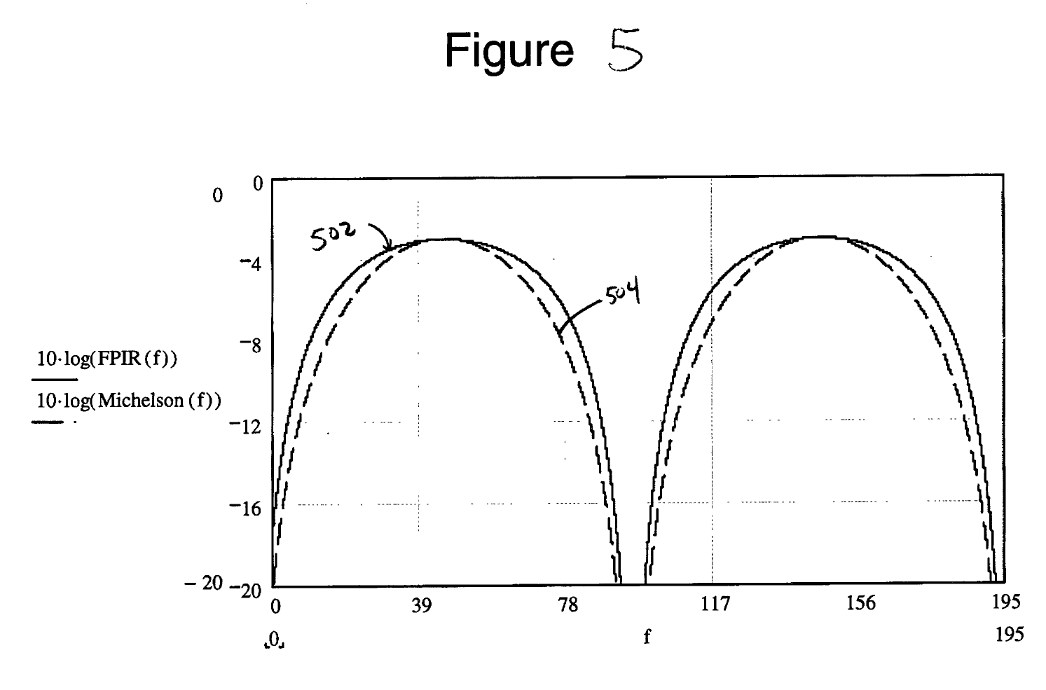

The inventors have observed that an FPIR 408 with appropriate values of end reflectivity for the surfaces (see, e.g., 102, 104 of FIG. 1) can closely approximate a MI or MZI pulse replicator. FIG. 5 shows the frequency response 502 of a reflected signal of a preferred FPIR 408 in which the first surface 102 to receive the input pulse has 17% mirror reflectivity and the second surface 104 has 24% mirror reflectivity. FIG. 5 also shows the frequency response 504 of a perfect (i.e., theoretical) MI or MZI. As shown in FIG. 5, the response 502 of certain embodiments of an FPIR 408 can be very close to an ideal MI or MZI. Moreover, the response 502 of the FPIR has essentially no polarization sensitivity (unlike an MI or MZI), since the FPIR 408 operates approximately at zero degrees of incidence relative to the input optical signal.

It has also been observed that the loss of exemplary FPIR devices 408 is approximately 3 dB, as shown in FIG. 5. However deviation from 17% and 24% reflectivity, such as 50% for the first and second surfaces can indeed result in lowering the 3 dB insertion loss at the expense of unequal pulse replication amplitudes which may be beneficial in certain applications. Under certain embodiments other reflectivity values may be chosen or adjusted so that the replicated pulses have about equal magnitudes.

It has also been observed that the FPIR device can exceed 40 dB of contrast between the maximum and minimum transmission amplitude. On the other hand, MI and MZI devices are limited to 25 dB contrast due to the polarization sensitivity of their beams-splitters.

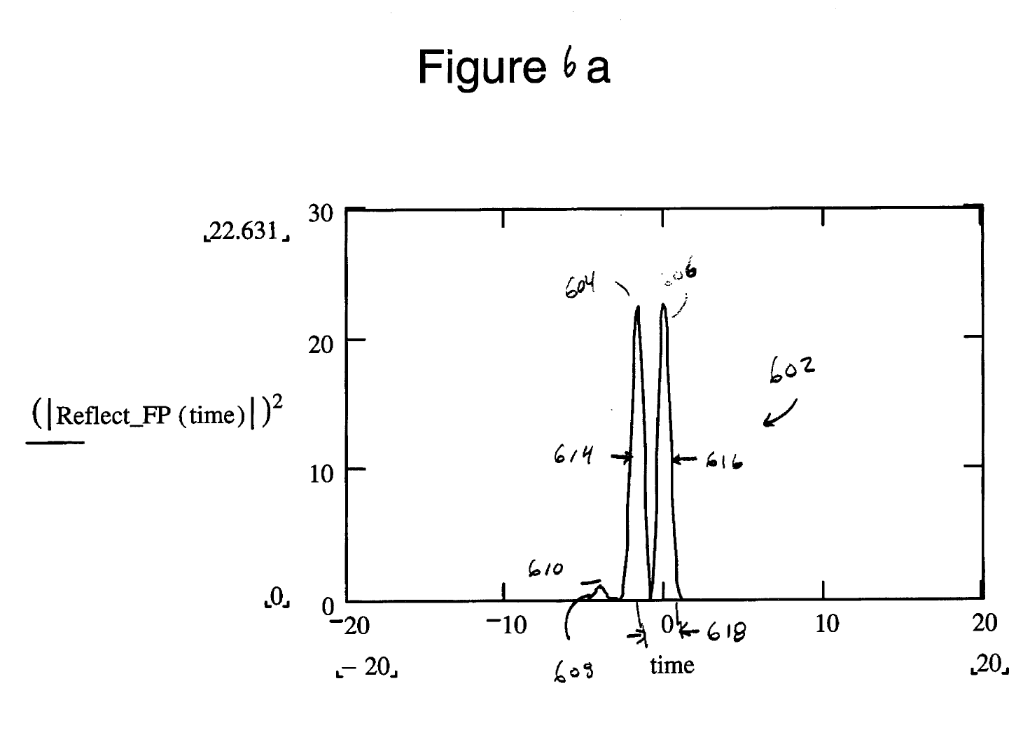

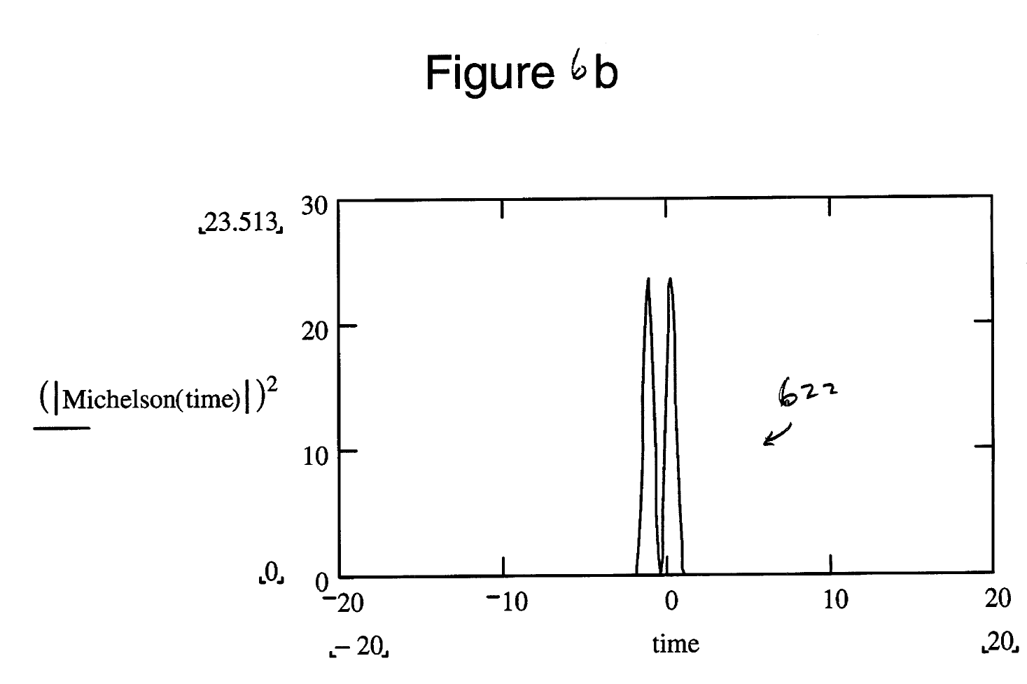

FIG. 6a shows the impulse response 562 of a preferred FPIR 408. The impulse response 602 shows two equal intensity pulses 604, 606 and a third low intensity pulse 608. The magnitude 610 of the third unwanted pulse is low enough so that it does not degrade the transmission performance in practical applications. The time delay 618 between pulses 604, 606 is a function of the round trip time of the FPIR. The round trip time may be tuned by thermal tuning.

FIG. 6b shows the impulse response 622 of an ideal MI or MZI. As shown with impulse response 622, an ideal MI produces two equal intensity pulses 624, 626 from a single input pulse.

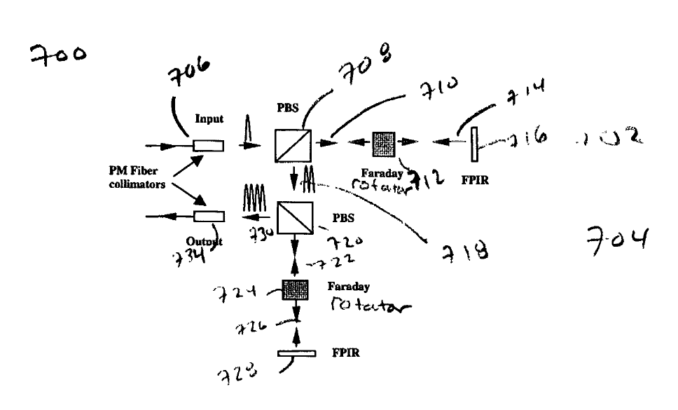

FIG. 7 shows another, exemplary embodiment of the invention. In this embodiment 700, there are two pulse replicators 702, 704 cascaded in series. An input signal is received on input link 706, which in this embodiment is polarization maintaining (PM) fiber or collimator. Consequently, in this embodiment, the polarization of the input signal is known. The signal is transmitted to polarization beam splitter (PBS) 708 which transmits the signal (having the polarization of the signal on input 706) to link 710. The signal on link 710 is then received by Faraday rotator 712, which changes the polarization of the signal by approximately 45 degrees. A polarization-changed signal emits from Fraday rotator 712 on to link 714, which transmits the signal to FPIR 716. FPIR 716, as described above, has its surface reflectivities and other parameters set to create a replicated pulse. The FPIR 716 then sends both pulses back on to link 714, where it is received by Fraday rotator 712. The Fraday rotator 712 again rotates the polarization by approximately 45 degrees and the signal is sent on to link 710 where it is received by PBS 708. In this case, however, PBS 708 transmits the signal received on link 710 (and which has a polarization that differs from that of signals on link 706) on to link 718.

The replicated pulses on link 718 are transmitted to the second of the two pulse replicators. By inspection, one will note that the pulse replicator 704 is analogous to that of 702. Specifically components 720-730 correspond to components 708-718. The pulse replicator 704 will receive the two pulses from replicator 702 and replicate them to make a four peak pulse. This wider time domain pulse requires less spectra in the frequency domain.

The various FPIRs can be tuned thermally, electro-optically, or through mechanical squeezing. For example, piezoelectric elements may be used to adjust the dimension d of the FPIR, and electric fields may be used to adjust the index of refraction of the media in the interior of the etalon of the FPIR. By such tuning, the phase between the may be altered.

Although FIG. 7 shows a two stage replication of the input pulse, the generalization to higher stages is straightforward.

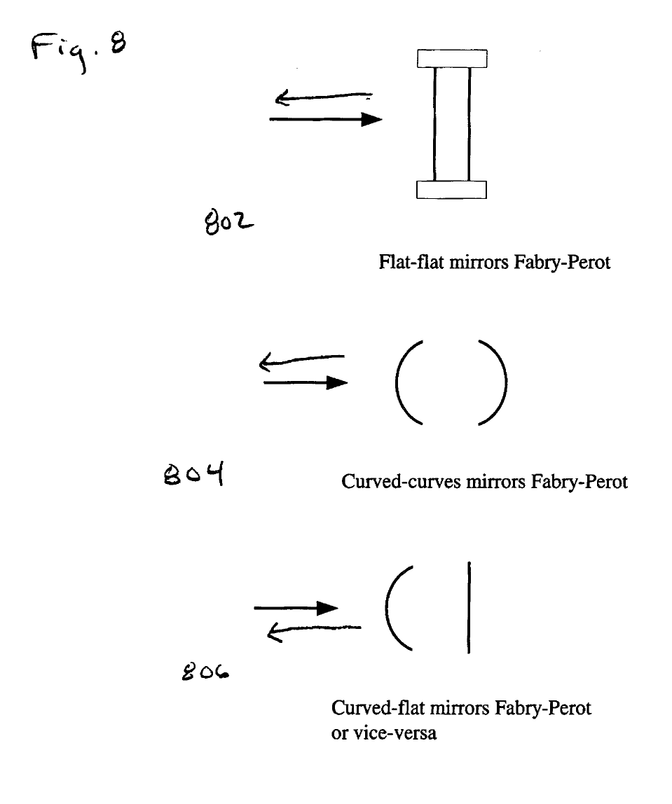

FIG. 8 shows other embodiments of the FPIRs. The FPIR 802 is a flat-flat arrangement and is similar to the one discussed above. FPIR 804 has two curved mirrors facing each other. FPIR 806 has a combination of a curved first mirror 808 and a flat second mirror 810. Alternatively (not shown) the first mirror may be flat and the second mirror may be curved. In each case, the volume between the mirrors may be filled with a material of a known refractive index or it may be devoid of matter. By changing the mirror's parallelism the cavity loss may be tuned.

The embodiments described above are particularly helpful when pulse replication is desired in which the pulses have the same or unequal amplitude. However, the above embodiments may be modified for other applications. Specifically, certain applications may desire a frequency profile in which the free spectral range and contrast described above may be useful. These applications may benefit from the stability of the FPIR arrangements described above.

It will be further appreciated that the scope of the present invention is not limited to the above-described embodiments, but rather is defined by the appended claims, and that these claims will encompass modifications of and improvements to what has been described.

What is claimed is:

1. An optical pulse replicator, comprising:
an optical signal distribution circuit having an input link, an output link, and a bidirectional link; and
a Fabry Perot interferometer in optical communication with the bi-directional link, wherein optical signals are communicated to the replicator on the input link of the optical signal distribution circuit, and wherein replicated pulses are communicated on the output link of the optical signal distribution circuit.

2. The optical pulse replicator of claim 1 wherein the Fabry Perot interferometer includes an etalon having a first and second reflective surfaces, wherein the first surface receives optical signals from the bi-directional link of the optical signal distribution circuit, and wherein the first surface and the second surface each have a corresponding reflectivity value so that the replicated pulses have substantially equal magnitude.

3. The optical pulse replicator of claim 1 wherein the Fabry Perot interferometer includes an etalon having a first and second reflective surfaces, wherein the first surface receives optical signals from the bi-directional link of the optical signal distribution circuit, and wherein the first surface has a reflectivity of about 17% and the second surface has a reflectivity of about 24%.

4. The optical pulse replicator of claim 1 wherein the Fabry Perot interferometer includes an etalon having a first and second reflective surfaces, wherein the first surface receives optical signals from the bi-directional link of the optical signal distribution circuit, and wherein the first and second surfaces have approximate equal reflectivity which ranges from 10% to 50%.

5. The optical pulse replicator of claim 1 wherein the optical signal distribution circuit includes a circulator.

6. The optical pulse replicator of claim 1 wherein the optical signal distribution circuit includes a coupler.

7. The optical pulse replicator of claim 1 wherein the optical signal distribution circuit includes a polarization beam splitter and a Farrady rotator.

8. The optical pulse replicator of claim 1 wherein the Fabry Perot interferometer is a tunable Fabry Perot interferometer.

9. The optical pulse replicator of claim 8 wherein the Fabry Perot interferometer is a thermally tunable.

10. The optical pulse replicator of claim 8 wherein the Fabry Perot interferometer is a electro-optically tunable.

11. The optical pulse replicator of claim 8 wherein the Fabry Perot interferometer is a mechanically tunable.

12. The optical pulse replicator of claim 1 wherein the optical signal distribution circuit includes a polarization maintaining fiber.

13. The optical pulse replicator of claim 1 wherein the Fabry Perot interferometer includes an etalon having a first and second reflective surfaces and wherein one of the first and second reflective surfaces is curved.

14. The optical pulse replicator of claim 1 wherein the Fabry Perot interferometer includes an etalon having a first and second reflective surface and wherein the first and second reflective surfaces are curved.

15. A method of replicating optical pulses, comprising:
providing an optical pulse to a Fabry Perot interferometer, operating in reflection mode and having surface reflectivities to generate a reflected pulse having approximately the same amplitude and the optical pulse; and
extracting replicated pulses from the Fabry Perot interferometer, generated in response to the optical pulse.

16. The method of claim 15 further comprising tuning the Fabry Perot interferometer to alter the time separation between the replicated pulses.

17. The method of claim 16 wherein the Fabry Perot interferometer is thermally tuned.

18. The method of claim 16 wherein the Fabry Perot interferometer is electro-optically tuned.

19. The method of claim 16 wherein the Fabry Perot interferometer is mechanically tuned.

20. The method of claim 15 further comprising changing the polarization of pulses reflected from the Fabry Perot interferometer and wherein replicated pulses are extracted based on their polarization.
